(19) United States
(12) Patent Application Publication
(10) Pub. No.: US 2026/0304554 A1
(43) Pub. Date: Oct. 1, 2026

(54) COMMUNICATION METHOD, ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/992,705

(22) PCT Filed: Jul. 18, 2022
(86) PCT No.: PCT/CN2022/106310

§ 371 Date: Jan. 9, 2025

(51) Int. Cl. H04W 76/30; H04L 1/1607; H04W 8/22

(52) U.S. Cl. CPC H04W 76/30; H04L 1/1614; H04W 8/22

(57) ABSTRACT

A communication method is applied to an access point multi-link device (AP MILD), and includes: determining a first radio frame, wherein the first radio frame includes at least one first identification bit, and the first identification bit indicates that an affiliated AP to which a corresponding target communication connection belongs is to be removed; and sending the first radio frame over at least one communication connection of the affiliated AP.

### CROSS-REFERENCE TO RELATED APPLICATIONS

The present application is a U.S. National Stage of International Application No. PCT/CN2022/106310 filed on Jul. 18, 2022, the entire contents of which are incorporated herein by reference for all purposes.

### TECHNICAL FIELD

Embodiments of the present disclosure relate to the field of mobile communication technology, and in particular, to a communication method, an electronic device and a storage medium.

### BACKGROUND

With the rapid development of mobile communication technology, the wireless fidelity (Wi-Fi) technology has made great progress in terms of transmission rate, throughput or the like. Currently, what are studied in the Wi-Fi technology are for example 320 Mhz bandwidth transmission, multi-band aggregation and collaboration or the like, and the main application scenarios of the Wi-Fi technology are for example video transmission, augmented reality (AR), virtual reality (VR) or the like.

Specifically, the multi-band aggregation and collaboration refers to that the communication between devices is performed in 2.4 GHz, 5.8 GHz, 6 GHz and other frequency bands at the same time. As for the scenario where the communication between devices is performed in a plurality of frequency bands at the same time, a new media access control (MAC) mechanism may be defined for management thereof. In addition, the multi-band aggregation and collaboration is expected to support low-latency transmission.

Currently, the multi-band aggregation and collaboration technology supports a maximum bandwidth of 320 MHz (160 MHz+160 MHz), and may also support a bandwidth of 240 MHz (160 MHz+80 MHz) and other bandwidths supported by an existing standard.

In the currently studied Wi-Fi technology, an access point multi-link device (AP MLD) may remove its affiliated AP.

### SUMMARY

Embodiments of the present disclosure provide a communication method, an electronic device and a storage medium.

In an aspect, an embodiment of the present disclosure provides a communication method, applied to an access point multi-link device (AP MLD), including:
determining a first radio frame, wherein the first radio frame includes at least one first identification bit, and the first identification bit indicates that an affiliated AP to which a corresponding target communication connection belongs is to be removed; and
sending the first radio frame over at least one communication connection of the affiliated AP.

In another aspect, an embodiment of the present disclosure further provides a communication method, applied to a non-access point multi-link device (Non-AP MLD), including:
receiving a first radio frame over at least one communication connection of an access point multi-link device (AP MILD), wherein the first radio frame includes at least one first identification bit, the first identification bit indicates that a corresponding target communication connection is to be removed, and the target communication connection is a communication connection of a to-be-removed affiliated AP of the AP MLD; and
de-associating with the target communication connection based on the first identification bit.

In another aspect, an embodiment of the present disclosure further provides an electronic device, which is an access point multi-link device (AP MHLD), including:
a determining module, configured to determine a first radio frame, wherein the first radio frame includes at least one first identification bit, and the first identification bit indicates that an affiliated AP to which a corresponding target communication connection belongs is to be removed; and
a sending module, configured to send the first radio frame over at least one communication connection of the affiliated AP.

In another aspect, an embodiment of the present disclosure further provides an electronic device, which is a non-access point multi-link device (Non-AP MLD), including:
a receiving module, configured to receive a first radio frame over at least one communication connection of an access point multi-link device (AP MILD), wherein the first radio frame includes at least one first identification bit, the first identification bit indicates that a corresponding target communication connection is to be removed, and the target communication connection is a communication connection of a to-be-removed affiliated AP of the AP MLD; and
a de-associating module, configured to de-associate with the target communication connection based on the first identification bit.

An embodiment of the present disclosure further provides an electronic device, including a memory, a processor and a computer program stored in the memory and runnable on the processor, and the processor, when executing the program, implements the method according to one or more of the embodiments of the present disclosure.

An embodiment of the present disclosure further provides a computer-readable storage medium having a computer program stored thereon that, when being executed by a processor, implements the method according to one or more of the embodiments of the present disclosure.

Additional aspects and advantages of the embodiments of the present disclosure will be partially given in the following description, which will become apparent from the following description or be learned through the practice of the present disclosure.

### BRIEF DESCRIPTION OF THE DRAWINGS

In order to more clearly illustrate the technical solutions of the embodiments of the present disclosure, the accompanying drawings, which are to be used in the description of the embodiments of the present disclosure, will be briefly introduced below. Obviously, the accompanying drawings in the following description are only some of the embodiments of the present disclosure, and a person skilled in the art may obtain other drawings based on these drawings without creative labor.

FIG. 1 illustrates a flow chart of a communication method provided in an embodiment of the present disclosure;

FIG. 2 illustrates another flow chart of a communication method provided in an embodiment of the present disclosure;

FIG. 3 illustrates yet another flow chart of a communication method provided in an embodiment the present disclosure;

FIG. 4 illustrates a schematic structure diagram of an electronic device provided in an embodiment of the present disclosure;

FIG. 5 illustrates another schematic structure diagram of an electronic device provided in an embodiment of the present disclosure; and

FIG. 6 illustrates yet another schematic structure diagram of an electronic device provided in an embodiment of the present disclosure.

### DETAILED DESCRIPTION

The term “and/or” in the embodiments of the present disclosure describes an association relationship between associated objects, indicating that three relationships may exist, for example, A and/or B may indicate: A alone, both A and B, and B alone. The character “/” generally indicates that the associated objects before and after the character are in an “or” relationship.

The term “a plurality of . . . ” in the embodiments of the present disclosure refers to two or more, and other quantifiers have similar meanings.

Embodiments will be described in detail herein, examples of which are shown in the accompanying drawings. When the following description relates to the accompanying drawings, unless otherwise indicated, the same reference numbers in different drawings indicate the same or similar elements. The implementations described in the following embodiments do not represent all implementations consistent with the present disclosure. Rather, they are merely examples of devices and methods consistent with some aspects of the present disclosure as detailed in the appended claims.

The term used in the present disclosure is only for describing a particular embodiment and is not intended to limit the present disclosure. The singular forms such as “a”, “an”, “said” and “the” used in the present disclosure and the appended claims are also intended to encompass plural forms, unless clearly indicated otherwise herein. It is also to be understood that the term “and/or” as used herein refers to and encompasses any or all possible combinations of one or more of the associated listed items.

It is to be understood that while the terms first, second, third or the like may be used in the present disclosure to describe various information, such information may not be limited by these terms. These terms are used only to distinguish the same type of information from one another. For example, without departing from the scope of the present disclosure, first information may also be referred to as second information, and similarly, second information may be referred to as first information. Depending on the context, for example, the term “if” as used herein may be interpreted as “while . . . ” or “when . . . ” or “in response to determining . . . ”.

The technical solution in the embodiments of the present disclosure will be described clearly and completely hereinafter in conjunction with the accompanying drawings in the embodiments of the present disclosure. Obviously, the described embodiments are only a part but not all of the embodiments of the present disclosure. Based on the embodiments in the present disclosure, all other embodiments obtained by a person skilled in the art without making creative labor fall within the protection scope of the present disclosure.

An embodiment of the present disclosure provides a communication method, an electronic device and a storage medium so as to provide an implementation of removing an affiliated AP.

The method, electronic device and apparatus are based on the same inventive concept. Since the method, electronic device and apparatus solve the problem with similar principles, the implementations of the method, electronic device and apparatus may be referred to each other, and the repetition thereof will not be described.

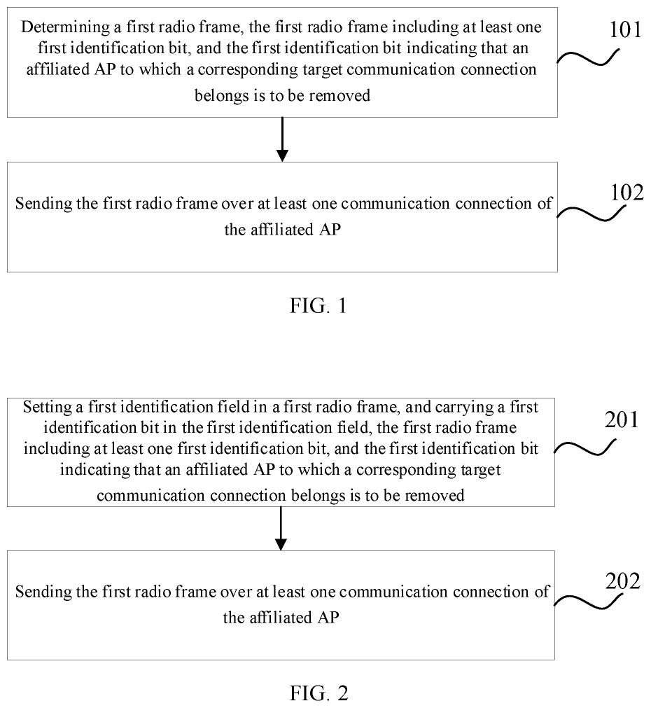

As illustrated in FIG. 1, an embodiment of the present disclosure provides a communication method, the method may be applied to an electronic device, the electronic device may be an access point multi-link device (AP MLD), and the method may include the following steps.

In step 101, a first radio frame is determined. The first radio frame includes at least one first identification bit, and the first identification bit indicates that an affiliated AP to which a corresponding target communication connection belongs is to be removed.

Generally, an access point multi-link device (AP MLD) may remove its affiliated AP at any time. For example, after determining to remove an affiliated AP-1, the AP MLD determines a first radio frame, and the first radio frame may be a basic service set transition management request (BTM Request) frame. For example, the AP MLD sends the BTM request frame on its own initiative or in response to a BSS transition management query frame. The AP MLD carries a first identification bit in the first radio frame to indicate by the first identification bit that an affiliated AP to which a target communication connection belongs is to be removed.

Specifically, the target communication connection is a communication connection of a to-be-removed affiliated AP, and thus it indicates by the first identification bit that this affiliated AP is to be removed. For example, the first identification bit may be an indication bit in a link bitmap field, and the link bitmap field is set to be 2 bytes, which then may include 16 link bitmap indication bits (i.e., the first identification bit) to identify that the affiliated AP supports 16 links. The link bitmap indication bit of “1” identifies that the corresponding communication connection thereof (i.e., the target communication connection) is to be removed.

In step 102, the first radio frame is sent over at least one communication connection of the affiliated AP.

The first radio frame includes one or at least two first identification bits, each of which may identify one communication connection respectively, so that the AP MLD may send the first radio frame over one communication connection, and thus indicates that a plurality of communication connections are to be removed by sending a single first radio frame, which can save signaling messages and reduce occupation of network resources. The AP MLD may also send the first radio frame over at least two communication connections.

In the embodiments of the present disclosure, the AP MLD determines the first radio frame and sends the first radio frame over at least one communication connection of the affiliated AP, the first radio frame includes at least one first identification bit, and the first identification bit indicates that the affiliated AP to which a corresponding target communication connection belongs is to be removed. The embodiments of the present disclosure provide a specific manner of removing the affiliated AP to improve the control mechanism of the affiliated AP.

As illustrated in FIG. 2, an embodiment of the present disclosure provides a communication method, the method may be applied to an electronic device, the electronic device may be an access point multi-link device (AP MLD), and the method includes:
step 201, setting a first identification field in a first radio frame, and carrying a first identification bit in the first identification field, the first radio frame including at least one first identification bit, and the first identification bit indicating that an affiliated AP to which a corresponding target communication connection belongs is to be removed;
step 202, sending the first radio frame over at least one communication connection of the affiliated AP.

The first radio frame may be a BTM request frame. For example, the AP MLD sends the BTM request frame on its own initiative or in response to a BSS transition management query frame. The AP MLD adds a new first identification field in the BTM request frame and carries the first identification bit in the first identification field. For example, the first identification field is a link bitmap field, the first identification bit is an indication bit in the link bitmap field, and the link bitmap field is set to be 2 bytes, which then may include 16 link bitmap indication bits (i.e., the first identification bit) to identify that the affiliated AP supports 16 links. The link bitmap indication bit of “1” identifies that the corresponding communication connection thereof (i.e., the target communication connection) is to be removed. As a first example, the format of an action field of the BTM request frame provided in an embodiment of the present disclosure is shown in Table 1 below:

TABLE 1

| Information | | WNM | Dialog | Request | Disassociation |
|---|---|---|---|---|---|
| Content | Category | Action | Token | Mode | Timer |
| Octets | 1 | 1 | 1 | 1 | 2 |
| Information | Validity | BSS | Session | BSS | link |
| Content | Interval | Termination | Information | Transition | bitmap |
| | | Duration | URL | Candidate | |
| | | (optional) | (optional) | List Entries | |
| | | | | (optional) | |
| Octets | 1 | 0 or 12 | variable | variable) | 2 or |
| | | | | | variable |

As shown in Table 1, a new link bitmap field is added in the BTM request frame, and the link bitmap field is set to be 2 bytes or variable number of bytes. When the link bitmap field is set to be 2 bytes, it then may include 16 link bitmap indication bits, i.e., the first identification bit.

An embodiment of the present disclosure provides a communication method, the method may be applied to an electronic device, the electronic device may be an access point multi-link device (AP MLD), and the method includes:
setting a first identification field in the first radio frame, carrying a first identification bit in the first identification field, setting a first subfield in a second identification field of the first radio frame, wherein an identification bit in the first subfield indicates whether the first identification field is present, the first radio frame includes at least one first identification bit, and the first identification bit indicates that an affiliated AP to which a corresponding target communication connection belongs is to be removed; and
sending the first radio frame over at least one communication connection of the affiliated AP.

In addition to adding a new first identification field in the first radio frame, a new first subfield is added in a second identification field of the first radio frame, and the first subfield indicates whether the first identification field is present in the first radio frame or not. With reference to the above first example, the first radio frame may be a basic service set transition management (BTM) request frame, and the second identification field may be a request mode field in Table 1. The first subfield is added in the second identification field of the first radio frame to indicate by the first subfield whether the link bitmap field is present or not. As a second example, referring to Table 2, the first subfield includes a link removal imminent subfield, and then the format of the request mode field is as shown in Table 2 below:

TABLE 2

| | Preferred | | | | | | |
|---|---|---|---|---|---|---|---|
| | Candidate | | | BSS | ESS | Link | |
| | List | | Disassociation | Termination | Disassociation | Removal | |
| Content | Included | Abridged | Imminent | Included | Imminent | Imminent | Reserved |
| Bits | 1 | 1 | 1 | 1 | 1 | 1 | 2 |
| Bits | B0 | B1 | B2 | B3 | B4 | B5 | B6 to |
| order | | | | | | | B7 |

As shown in Table 2, the link removal imminent subfield occupies one bit, and the link removal imminent subfield set to be “1”, which identifies that the first identification field is present in the BTM request frame.

An embodiment of the present disclosure provides a communication method, the method may be applied to an electronic device, the electronic device may be an access point multi-link device (AP MILD), and the method includes:
determining a first radio frame, wherein the first radio frame includes at least one first identification bit, and the first identification bit indicates that an affiliated AP to which a corresponding target communication connection belongs is to be removed; and
sending the first radio frame over at least one communication connection of the affiliated AP with a legacy STA not supporting a predetermined function.

For example, the predetermined function is a function supported by the 802.11be protocol. In order to ensure that the legacy STA can achieve de-association, the AP MLD may send the first radio frame over a connection where an association has been established in case where the associated connection has a legacy STA, thereby avoiding that the legacy STA cannot de-associate with the to-be-removed affiliated AP.

In an embodiment, the method further includes:
carrying a second identification bit in an extended capabilities information element, the second identification bit indicating information that the AP MILD supports a capability of removing the affiliated AP.

The AP (e.g., the AP MILD) and an STA may add a new second identification bit in the extended capabilities, to identify by the second identification bit whether it supports the capability of removing affiliated AP, or the AP and the STA use the basic service set transition management (BTM) information identification bit in the existing extended capabilities to identify whether it supports the capability of removing the affiliated AP.

In the embodiments of the present disclosure, an AP MLD determines a first radio frame and sends the first radio frame over at least one communication connection of the affiliated AP, the first radio frame includes at least one first identification bit, and the first identification bit indicates that an affiliated AP to which a corresponding target communication connection belongs is to be removed.

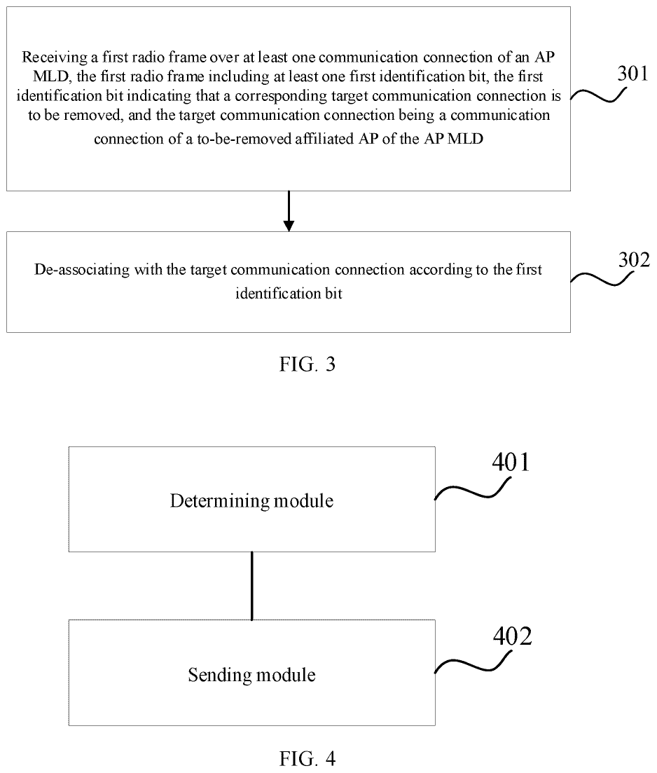

As illustrated in FIG. 3, an embodiment of the present disclosure provides a communication method, the method may be applied to a non-access point multi-link device (Non-AP MILD), and the method may include the following steps.

In step 301, a first radio frame is received over at least one communication connection of an access point multi-link device (AP MILD). The first radio frame includes at least one first identification bit, the first identification bit indicates that a corresponding target communication connection is to be removed, and the target communication connection is a communication connection of a to-be-removed affiliated AP of the AP MILD.

Generally, an access point multi-link device (AP MLD) may remove its affiliated AP at any time. For example, the AP MLD sends the BTM request frame on its own initiative or in response to a BSS transition management query frame. The AP MLD carries a first identification bit in the first radio frame to indicate by the first identification bit that an affiliated AP to which a target communication connection belongs is to be removed.

Specifically, the target communication connection is a communication connection of a to-be-removed affiliated AP, and thus it indicates by the first identification bit that this affiliated AP is to be removed. For example, the first identification bit may be an indication bit in a link bitmap field, and the link bitmap field is set to be 2 bytes, which then may include 16 link bitmap indication bits (i.e., the first identification bit) to identify that the affiliated AP supports 16 links. The link bitmap indication bit of “1” identifies that the corresponding communication connection thereof (i.e., the target communication connection) is to be removed.

The first radio frame includes one or at least two first identification bits, each of which may identify one communication connection respectively, so that the Non-AP MLD may receive the first radio frame over one communication connection, and thus determine that a plurality of communication connections are to be removed by receiving a single first radio frame, which can save signaling messages and reduce occupation of network resources. The Non-AP MLD may also receive the first radio frame over at least two communication connections.

In step 302, the target communication connection is de-associated based on the first identification bit.

The Non-AP MLD determines a to-be-removed target communication connection based on the first identification bit and disassociates with the target communication connection.

In an embodiment, the first radio frame includes a first identification field, and the first identification bit is carried in the first identification field.

In an embodiment, a second identification field of the first radio frame includes a first subfield, and an identification bit in the first subfield indicates whether the first identification field is present.

In an embodiment, the first identification field includes a link bitmap field.

In an embodiment, the first radio frame includes a basic service set transition management (BTM) request frame;
the second identification field includes a request mode field; and/or
the first subfield includes a link removal imminent subfield.

In an embodiment, the method further includes:
carrying a second identification bit in an extended capabilities information element, the second identification bit indicating information that the AP MILD supports a capability of removing the affiliated AP.

An STA may add a new second identification bit in the extended capabilities of a second radio frame, to identify by the second identification bit whether it supports the capability of removing an affiliated AP, and the second radio frame may be a radio frame carrying the extended capabilities. Alternatively, the STAuse the basic service settransition management (BTM) information identification bit in the existing extended capabilities to identify whether it supports the capability of removing the affiliated AP.

In an embodiment, the method further includes:
obtaining time information in a disassociation timer field of the first radio frame, and determining, based on the time information, a time at which each target communication connection is to be removed; or
obtaining target beacon transmission time (TBTT) offset information in reduced neighbor report (RNR) information element, and determining, based on the TBTT offset information and the first identification bit, the time at which each target communication connection is to be removed.

As shown in the aforementioned Table 1, the first radio frame includes the disassociation timer field, and the disassociation timer field indicates a time at which the AP MLD sends a disassociation frame to the Non-AP MILD, i.e., the disassociation timer field is a waiting time from sending the first radio frame to removing the connection of the affiliated AP. For example, the disassociation timer field is set to be the number of target beacon transmission times (TBTTs), which identifies the number of beacon transmissions before transmitting the disassociation frame, i.e., how many TBTT beacon frames will be sent before the AP MILD sends the disassociation frame over the current connection and removes the current connection. The Non-AP MLD determines the corresponding time when each target communication connection is removed based on the number of TBTTs, and disassociates with the target communication connection after the target communication connection is removed.

In addition, the Non-AP MLD may also obtain target beacon transmission time (TBTT) offset information in reduced neighbor report (RNR) information element. By taking that the first identification field includes a link bitmap field as an example, the first identification bit of the removed communication connection may be set to be “1” (or “0”), the Non-AP MLD determines the other connections that are to be removed based on the first identification bit, and then determines a time when the connection is removed based on the TBTT offset time of each connection. Alternatively, each to-be-removed connection has one disassociation timer field, and the Non-AP MLD determines how many disassociation timer fields are included, and obtains the TBTT offset time of each connection by dividing the TBTT offset time by the number of disassociation timer fields, and then determines the time when the connection is removed.

In the embodiments of the present disclosure, the Non-AP MLD receives the first radio frame over at least one communication connection of the access point multi-link device (AP MLD), and de-associates with the target communication connection based on the first identification bit, the first radio frame includes at least one first identification bit, and the first identification bit indicates that the affiliated AP to which a corresponding target communication connection belongs is to be removed.

Referring to FIG. 4, based on the same principle as the method provided by the embodiment of the present disclosure, an embodiment of the present disclosure also provides an electronic device. The electronic device is an access point multi-link device (AP MLD), and includes:
a determining module 401, configured to determine a first radio frame, wherein the first radio frame includes at least one first identification bit, and the first identification bit indicates that an affiliated AP to which a corresponding target communication connection belongs is to be removed; and
a sending module 402, configured to send the first radio frame over at least one communication connection of the affiliated AP.

In an embodiment, the determining module 401 is configured to:
set a first identification field in the first radio frame, and carry the first identification bit in the first identification field.

In an embodiment, the determining module 401 is configured to:
set a first subfield in a second identification field of the first radio frame, wherein an identification bit in the first subfield indicates whether the first identification field is present.

In an embodiment, the first identification field includes a link bitmap field.

In an embodiment, the first radio frame includes a basic service set transition management (BTM) request frame,
the second identification field includes a request mode field, and/or
the first subfield includes a link removal imminent subfield.

In an embodiment, the sending module 402 is configured to:
send the first radio frame over at least one communication connection of the affiliated AP with a legacy STA not supporting a predetermined function.

In an embodiment, the determining module 401 is further configured to:
carry a second identification bit in an extended capabilities information element, the second identification bit indicating information that the AP MLD supports a capability of removing the affiliated AP.

In the embodiments of the present disclosure, the determining module 401 determines the first radio frame, and the sending module 402 sends the first radio frame over at least one communication connection of the affiliated AP, the first radio frame includes at least one first identification bit, and the first identification bit indicates that the affiliated AP to which a corresponding target communication connection belongs is to be removed.

An embodiment of the present disclosure provides a communication device, which is applied to an access point multi-link device (AP MILD), and includes:
a radio frame determining module, configured to determine a first radio frame, wherein the first radio frame includes at least one first identification bit, and the first identification bit indicates that an affiliated AP to which a corresponding target communication connection belongs is to be removed; and
a radio frame sending module, configured to send the first radio frame over at least one communication connection of the affiliated AP.

The device further includes other modules in the electronic device of the above embodiments, which will be not repeated herein.

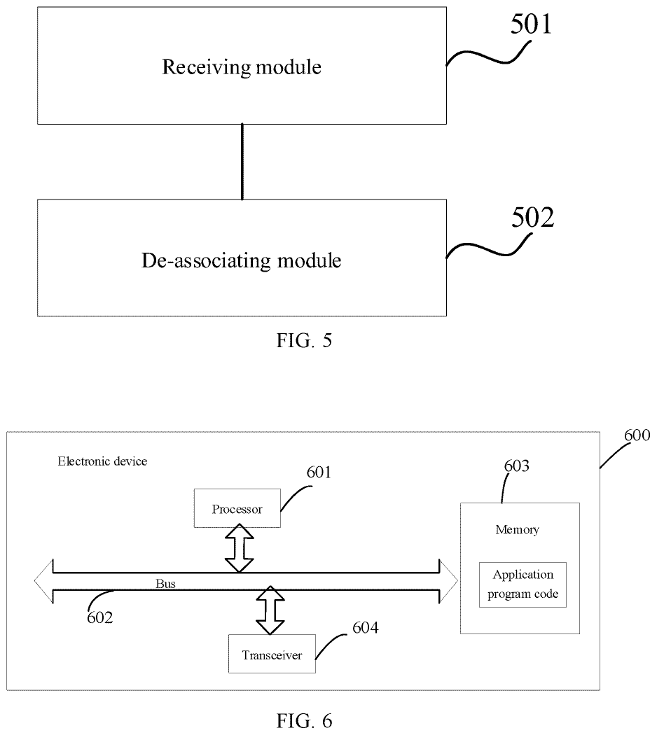

Referring to FIG. 5, based on the same principle as the method provided by the embodiment of the present disclosure, an embodiment of the present disclosure also provides an electronic device. The electronic device is a non-access point multi-link device (Non-AP MLD), and includes:
a receiving module 501, configured to receive a first radio frame over at least one communication connection of an access point multi-link device (AP MILD), wherein the first radio frame includes at least one first identification bit, the first identification bit indicates that a corresponding target communication connection is to be removed, and the target communication connection is a communication connection of a to-be-removed affiliated AP of the AP MLD; and
a de-associating module 502, configured to de-associate with the target communication connection based on the first identification bit.

In an embodiment, the first radio frame includes a first identification field, and the first identification bit is carried in the first identification field.

In an embodiment, a second identification field of the first radio frame includes a first subfield, and an identification bit in the first subfield indicates whether the first identification field is present.

In an embodiment, the first identification field includes a link bitmap field.

In an embodiment, the first radio frame includes a basic service set transition management (BTM) request frame;
the second identification field includes a request mode field; and/or
the first subfield includes a link removal imminent subfield.

In an embodiment, the electronic device further includes:
an identifying module, configured to carry a second identification bit in an extended capabilities information element, the second identification bit indicating information that the AP MLD supports a capability of removing the affiliated AP.

In an embodiment, the electronic device further includes:
a first determining module, configured to obtain time information in a disassociation timer field of the first radio frame, and determine, based on the time information, a time at which each target communication connection is to be removed; or
a second determining module, configured to obtain target beacon transmission time (TBTT) offset information in reduced neighbor report (RNR) information element, and determine, based on the TBTT offset information and the first identification bit, the time at which each target communication connection is to be removed.

In the embodiments of the present disclosure, the receiving module 501 receives the first radio frame over at least one communication connection of the access point multi-link device (AP MLD), and the de-associating module 502 de-associates with the target communication connection based on the first identification bit, the first radio frame includes at least one first identification bit, and the first identification bit indicates that the affiliated AP to which a corresponding target communication connection belongs is to be removed,

An embodiment of the present disclosure further provides a communication device, which is applied to a non-access point multi-link device (Non-AP MLD), and includes:
a radio frame receiving module, configured to receive a first radio frame over at least one communication connection of an access point multi-link device (AP MLD), wherein the first radio frame includes at least one first identification bit, the first identification bit indicates that a corresponding target communication connection is to be removed, and the target communication connection is a communication connection of a to-be-removed affiliated AP of the AP MLD; and
a de-associating module, configured to de-associate with the target communication connection based on the first identification bit.

The device further includes other modules in the electronic device of the above embodiments, which will be not repeated herein.

In an embodiment, an embodiment of the present disclosure further provides an electronic device, and as shown in FIG. 6, the electronic device 600 shown in FIG. 6 may be a server, which includes a processor 601 and a memory 603. The processor 601 and the memory 603 are connected, e.g., via a bus 602. In an embodiment, the electronic device 600 may also include a transceiver 604. It is to be noted that in practical application, the number of the transceiver 604 is not limited to one, and the structure of the electronic device 600 does not limit the embodiments of the present disclosure.

The processor 601 may be a CPU (Central Processing Unit), a general-purpose processor, a DSP (Digital Signal Processor), an ASIC (Application Specific Integrated Circuit), FPGA (Field Programmable Gate Array) or other programmable logic device, a transistor logic device, a hardware component, or any combination thereof. It may implement or execute various logic blocks, modules, and circuits described in conjunction with the present disclosure. The processor 601 may also be a combination that implements computing functions, such as a combination including one or more microprocessor, a combination of a DSP and a microprocessor, and the like.

The bus 602 may include a path for transferring information between the components described above. The bus 602 may be a PCI (Peripheral Component Interconnect) bus, an EISA (Extended Industry Standard Architecture) bus or the like. The bus 602 may be divided into an address bus, a data bus, a control bus or the like. For ease of representation, only one thick line is shown in FIG. 6, which however does not mean that there is only one bus or one type of bus.

The memory 603 may be a ROM (Read Only Memory) or other type of static memory device that can store static information and instructions, and a RAM (Random Access Memory) or other type of dynamic memory device that can store information and instructions, or may also be an EEPROM (Electrically Erasable Programmable Read Only Memory), CD-ROM (Compact Disc Read Only Memory) or other optical disk storage, optical disc storage (including compressed optical discs, laser discs, compact discs, digital general purpose discs, Blu-ray discs, etc.), magnetic disk storage media, other magnetic storage devices, or any other media capable of carrying or storing expected program codes having instruction or data structure form and capable of being accessed by a computer, which is not specifically limited herein.

The memory 603 is used to store application program codes for executing the solution of the present disclosure and is controlled and executed by processor 601. The processor 601 is used to execute the application program codes stored in the memory 603 to implement that shown in the above method embodiments.

The electronic device includes, but is not limited to: a mobile terminal such as a mobile phone, a laptop computer, a digital broadcast receiver, a PDA (personal digital assistant), a PAD (portable Android device), a PMP (portable multimedia player), an in-vehicle terminal (such as in-vehicle navigation terminal), or the like; and a fixed terminal such as a digital TV, a desktop computer, or the like. The electronic device shown in FIG. 6 is merely an example and should not impose any limitation on the functionality and application scope of the embodiments of the present disclosure.

The server provided in the present disclosure may be a standalone physical server, may be a server cluster or a distributed system formed by a plurality of physical servers, or may also be a cloud server providing basic cloud computing services such as cloud services, cloud databases, cloud computation, cloud functions, cloud storage, network services, cloud communications, middleware services, field name services, security services, CDN, and big data and artificial intelligence platforms. The terminals may be smartphones, tablets, laptops, desktop computers, smart speakers, smart watches, and the like, but are not limited thereto. The terminal and the server may be connected directly or indirectly via wired or wireless communication, which is not limited in the present disclosure.

An embodiment of the present disclosure provides a computer-readable storage medium having a computer program stored thereon which, when runs on a computer, enables the computer to execute that in the above method embodiments.

It is to be understood that although the individual steps in the flowchart of the accompanying drawings are shown in sequence as indicated by the arrows, the steps are not necessarily executed sequentially in the order indicated by the arrows. Unless expressly stated herein, the execution of these steps is not strictly limited in order, and they may be executed in other orders. Moreover, at least a portion of the steps in the flowchart of the accompanying drawings may include a plurality of sub-steps or a plurality of phases, which are not necessarily executed or completed at the same moment but may be executed at different moments, and they may not be executed sequentially, but may be executed in turn or alternately with the other steps or at least a portion of sub-steps or phases of the other steps.

It is to be noted that the computer-readable medium described above in the present disclosure may be a computer-readable signal medium or a computer-readable storage medium or any combination thereof. The computer-readable storage medium may be but is not limited to for example a system, device, or element of electricity, magnetism, light, electromagnetism, infrared ray, or semiconductor, or any combination thereof. More specific examples of the computer-readable storage media may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction-executing system, device, or element. And in the present disclosure, the computer-readable signal medium may include a data signal propagated in a baseband or as part of a carrier carrying computer-readable program code. Such propagated data signals may take a variety of forms, including, but not limited to, electromagnetic signals, optical signals, or any suitable combination thereof. The computer-readable signal medium may also be any computer-readable medium other than the computer-readable storage medium that may send, propagate, or transmit a program for use by or in conjunction with an instruction-executing system, device, or element. The program code contained on the computer-readable medium may be transmitted using any suitable medium, including, but not limited to: wire, optical cable, RF (Radio Frequency), or the like, or any suitable combination thereof.

The above computer-readable medium may be contained in the above electronic device; or may exist separately and not be assembled into the electronic device.

The above computer-readable medium carries one or more programs that, when being executed by the electronic device, cause the electronic device to perform the method in the above embodiments.

According to an aspect of the present disclosure, there is provided a computer program product or computer program including computer instructions which are stored in a computer-readable storage medium. A processor of a computer device reads the computer instructions from the computer-readable storage medium, and the processor executes the computer instructions such that the computer device performs the method provided in the various implementations described above.

The computer program code for performing the operations of the present disclosure may be written in one or more programming languages or combinations thereof, including object-oriented programming languages—such as Java, Smalltalk, C++—and procedural programming languages—such as the ‘C’ language or similar programming languages. The program code may be executed entirely on a user computer, executed partially on the user computer, executed as a stand-alone software package, executed partially on the user computer and partially on a remote computer, or executed entirely on a remote computer or server. In the case of the remote computer, the remote computer may be connected to the user computer via any kind of network, including a local area network (LAN) or a wide area network (WAN), or may be connected to an external computer (e.g., by using the Internet of an Internet service provider).

The flowcharts and block diagrams in the accompanying drawings illustrate the system architecture, functionality, and operation that may be implemented by the systems, methods, and computer program products according to various embodiments of the present disclosure. In this regard, each block in the flowcharts or block diagrams may represent a module, program segment, or portion of code that contains one or more executable instructions for implementing a specified logical function. It is also to be noted that in some alternative implementations, the functions indicated in the blocks may also occur in a different order than that indicated in the accompanying drawings. For example, two consecutively represented blocks may actually be executed substantially in parallel, and they may sometimes be executed in a reverse order, depending on the function involved. It is also to be noted that each block in the block diagrams and/or flowcharts, and a combination of the blocks in the block diagrams and/or flowcharts, may be implemented with a dedicated hardware-based system that performs a specified function or operation, or may be implemented with a combination of dedicated hardware and computer instructions.

The modules involved in the description of the embodiments of the present disclosure may be implemented by way of software or may be implemented by way of hardware. The name of a module does not constitute a limitation on the module in some cases, for example, a module A may also be described as “a module A for performing an operation B”.

The above description is only a preferred embodiment of the present disclosure and an illustration of the technical principle applied. A person skilled in the art should understand that the scope of the present disclosure is not limited to a technical solution formed by a particular combination of the above-described technical features, but also covers other technical solutions formed by any combination of the above-described technical features or their equivalents without departing from the above-described concept of the present disclosure, for example, a technical solution formed by replacing the above features with technical features having similar functions to that disclosed in the present disclosure (which however not limited thereto).

1. A communication method, applied to an access point multi-link device (AP MLD), comprising:
determining a first radio frame, wherein the first radio frame comprises at least one first identification bit, and the first identification bit indicates that an affiliated AP to which a corresponding target communication connection belongs is to be removed; and
sending the first radio frame over at least one communication connection of the affiliated AP.

2. The communication method according to claim 1, wherein determining the first radio frame comprises:
setting a first identification field in the first radio frame, and carrying the first identification bit in the first identification field.

3. The communication method according to claim 2, wherein determining the first radio frame further comprises:
setting a first subfield in a second identification field of the first radio frame, wherein an identification bit in the first subfield indicates whether the first identification field is present.

4. The communication method according to claim 3, wherein the first identification field comprises a link bitmap field.

5. The communication method according to claim 4, wherein the first radio frame comprises a basic service set transition management (BTM) request frame,
the second identification field comprises a request mode field, and/or
the first subfield comprises a link removal imminent subfield.

6. The communication method according to claim 1, wherein sending the first radio frame over the at least one communication connection of the affiliated AP comprises:
sending the first radio frame over at least one communication connection of the affiliated AP with a legacy STA not supporting a predetermined function.

7. The communication method according to claim 1, further comprising:
carrying a second identification bit in an extended capabilities information element, the second identification bit indicating information that the AP MLD supports a capability of removing the affiliated AP.

8. A communication method, applied to a non-access point multi-link device (Non-AP MLD), comprising:
receiving a first radio frame over at least one communication connection of an access point multi-link device (AP MLD), wherein the first radio frame comprises at least one first identification bit, the first identification bit indicates that a corresponding target communication connection is to be removed, and the target communication connection is a communication connection of a to-be-removed affiliated AP of the AP MLD; and
de-associating with the target communication connection based on the first identification bit.

9. The communication method according to claim 8, further comprising:
obtaining time information in a disassociation timer field of the first radio frame, and determining, based on the time information, a time at which each target communication connection is to be removed; or
obtaining target beacon transmission time (TBTT) offset information in reduced neighbor report (RNR) information element, and determining, based on the TBTT offset information and the first identification bit, the time at which each target communication connection is to be removed.

10-13. (canceled)

14. An electronic device, applied to an access point multi-link device (AP MILD), comprising:
a processor; and
a memory storing instructions executable by the processor,
wherein the processor is configured to:
determine a first radio frame, wherein the first radio frame comprises at least one first identification bit, and the first identification bit indicates that an affiliated AP to which a corresponding target communication connection belongs is to be removed; and
send the first radio frame over at least one communication connection of the affiliated AP.

15. The electronic device according to claim 14, wherein when determining the first radio frame, the processor is further configured to:
set a first identification field in the first radio frame, and carrying the first identification bit in the first identification field.

16. The electronic device according to claim 15, wherein when determining the first radio frame, the processor is further configured to:
set a first subfield in a second identification field of the first radio frame, wherein an identification bit in the first subfield indicates whether the first identification field is present.

17. The electronic device according to claim 16, wherein the first identification field comprises a link bitmap field.

18. The electronic device according to claim 17, wherein the first radio frame comprises a basic service set transition management (BTM) request frame,
the second identification field comprises a request mode field, and/or
the first subfield comprises a link removal imminent subfield.

19. The electronic device according to claim 14, wherein when sending the first radio frame over the at least one communication connection of the affiliated AP, the processor is further configured to:
send the first radio frame over at least one communication connection of the affiliated AP with a legacy STA not supporting a predetermined function.

20. The electronic device according to claim 14, wherein the processor is further configured to:
carry a second identification bit in an extended capabilities information element, the second identification bit indicating information that the AP MLD supports a capability of removing the affiliated AP.

21. An electronic device, applied to a non-access point multi-link device (Non-AP MLD), comprising:
a processor; and
a memory storing instructions executable by the processor,
wherein the processor is configured to implement the communication method according to claim 8.

22. The electronic device according to claim 21, wherein the communication method further comprises:
obtaining time information in a disassociation timer field of the first radio frame, and determining, based on the time information, a time at which each target communication connection is to be removed; or
obtaining target beacon transmission time (TBTT) offset information in reduced neighbor report (RNR) information element, and determining, based on the TBTT offset information and the first identification bit, the time at which each target communication connection is to be removed.

23. A non-transitory computer-readable storage medium storing instructions that, when executed by one or more processors of a device, cause the device to implement the communication method according to claim 1.

24. A non-transitory computer-readable storage medium storing instructions that, when executed by one or more processors of a device, cause the device to implement the communication method according to claim 8.
